(19) United States
(12) Patent Application Publication
(10) Pub. No.: US 2009/0253570 A1
(43) Pub. Date: Oct. 8, 2009

(54) High-temperature-stable ceramic layers and shaped bodies

(76) Inventors: Martin Jost, Heusweiler (DE); Ralph Nonninger, Saarbrucken (DE)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 11/990,817

(22) PCT Filed: Aug. 22, 2006
(86) PCT No.: PCT/EP2006/008246

§ 371 Date: May 1, 2008

(30) Foreign Application Priority Data
Aug. 22, 2005 (DE) 10 2005 040 582.7

(51) Int. Cl. C04B 35/111

(52) U.S. Cl. 501/127; 501/132; 501/126

(57) ABSTRACT

A composition includes particles of an inorganic component A and particles of an inorganic component B which together can form a eutectic system and react at least partly with one another at a sintering temperature, resulting in formation of at least one ternary chemical compound of the spinel type. The composition can be applied to high-temperature-stable ceramic layers, coatings and shaped bodies and also their production, their uses and compositions for producing them.

### RELATED APPLICATION

This is a §371 of International Application No. PCT/EP2006/008246, with an international filing date of Aug. 22, 2006 (WO 2007/022957 A1, published Mar. 1, 2007), which is based on German Patent Application No. 102005040582.7, filed Aug. 22, 2005.

### TECHNICAL FIELD

This disclosure relates to high-temperature-stable ceramic layers, coatings and shaped bodies and also their production, their uses and, in particular, compositions for producing them.

It is known from the prior art that inorganic nanoparticles are suitable as inorganic binder phase in the production of ceramics. Thus, WO 03/93195 states that nanoparticles are, owing to their high surface energies, able to undergo a diffusion process at temperatures above 300° C. which can join relatively coarse particles to one another on an atomic level. The nanoparticles used are dissolved in the process and lose their previous shape. This process can also be described as the nanoparticles becoming positioned at the contact points between the grains of the matrix and leading to “adhesive bonding” of the grains of the matrix. This process usually results in porous ceramic layers or porous shaped ceramic bodies.

It has now been found in practical use that the inorganic layers or shaped bodies produced in this way can be particularly susceptible to chemical attack at elevated temperatures. In this case, the nanoparticles forming the binder phase represent the weak point in the microstructure of the layers and shaped bodies bonded by means of nanoparticles. In the case of chemical attack, in particular at high temperatures, the above-mentioned binder phase is lost, which drastically and irreversibly reduces the mechanical stability of the ceramic.

It could therefore be advantageous to provide a ceramic which has improved properties and is, in particular, stable to chemical attack at high temperatures. The desired ceramic should combine good high-temperature properties with the positive properties of the above-mentioned nanoparticles-bonded ceramics at lower temperatures. Apart from the ceramics themselves, a process for producing them should be provided.

### SUMMARY

We provide a composition for producing high-temperature-stable ceramic layers, coatings and shaped bodies, which comprises particles of an inorganic component A and particles of an inorganic component B which together form a eutectic mixture and react at least partly with one another at a sintering temperature, resulting in formation of at least one ternary spinel compound.

We also provide a ceramic reaction product produced from the composition comprising at least one inorganic compound formed by a chemical reaction during sintering and also at least one further inorganic compound.

We further provide a process for producing a high-temperature-stable ceramic coating on an article, comprising applying the composition to the article, removing solvent present in the composition and sintering the composition.

We still further provide an article comprising the reaction product.

### BRIEF DESCRIPTION OF THE DRAWINGS

The above-mentioned and further advantages of the disclosure can be seen from the description of the following examples and figures. The individual features described herein can be realized either alone or in combination with one another.

In the figures:

FIG. 1 shows a scanning electron micrograph of the ceramic microstructure produced as described in example 1.

FIG. 2 shows an HR scanning electron micrograph (high-resolution scanning electron micrograph of a polished section) of the ceramic microstructure produced as described in example 1.

FIG. 3 shows an EDX spectrum of the large light-colored regions in FIG. 2.

FIG. 4 shows a protective layer which has been contacted with power station slag.

### DETAILED DESCRIPTION

A composition according that produces high-temperature-stable ceramic layers, coatings and shaped bodies is provided and comprises particles of an inorganic component A and particles of an inorganic component B. These can together form a eutectic mixture and react at least partly with one another at the sintering temperature, resulting in formation of at least one ternary chemical compound (i.e. a compound composed of 3 elements), in particular, of the spinel type.

The ceramic layers, coatings and shaped bodies can, in some preferred aspects, be siliceous ceramics or island silicates such as garnets, in particular, Y₃Al₅O₁₂ (YAL) and Y₃Fe₅O₁₂ (YAG). However, particular preference is given to oxide ceramics, i.e. ceramics composed of oxides or oxide compounds and preferably having a low silica content, if any.

The term “high-temperature-stable” means that the ceramic layers, coatings and shaped bodies are resistant to chemical attack (acidic or basic) at high temperatures up to at least 900° C., preferably up to 1100° C., in particular, up to 1400° C. It is assumed that this high resistance is at least partly due to formation of a high-temperature-stable phase (the ternary compound) during sintering.

In a eutectic mixture, at least two components which are immiscible with one another in the solid state are present in such a ratio that they become liquid or solid as a whole at a particular temperature. In general, this temperature is below the melting points of the individual components.

Compounds of the spinel type are, in particular, combinations of divalent metal ions with trivalent or tetravalent metal ions together with oxygen and/or other chalcogens and having the general formula AB₂X₄ (A=divalent metal, B=trivalent or tetravalent metal and X=chalcogen, in particular O, S).

A composition preferably comprises not only the particles of the components A and B, but also nanosize particles of an inorganic component C, in particular, one having an average particle size of <100 nm. The average particle size of the nanosize particles is, in particular, in the range from about 1 nm to about 100 nm, particularly preferably from about 5 nm to about 50 nm, in particular from about 5 nm to about 25 nm.

During sintering of such a composition, the nanoscale particles act as inorganic binder (as described in WO 03/93195, the subject matter of which is incorporated herein by reference) and strengthen the resulting ceramic layer at temperatures below 1000° C. At temperatures above 1000° C., in particular above 1100° C., the particles of the inorganic component A used and particles of the inorganic component B form the above-mentioned high-temperature-stable phase. This formation may likewise be supported by the presence of the nanoparticles.

In further preferred aspects of the composition, in addition to or instead of the particles of the component C being nanosize, the particles of component A and/or of component B are also at least partly nanosize. Like the particles of the component C, they preferably also have an average particle size in the range from about 1 nm to about 100 nm. Within this range, greater preference is given to particles having sizes in the range from about 5 nm to about 50 nm, in particular from about 5 nm to about 25 nm. Such an embodiment, too, makes the above-described strengthening of the ceramic layer formed on sintering possible at relatively low temperatures, possibly also in the absence of particles of component C.

Component A preferably comprises at least one metal compound having, in particular, a divalent metal ion, with the metal compound preferably being selected from the group consisting of oxidic Cu, Fe, Co, Zn, Mn, Ce, Sn, Cd, In, Ta, Nb, V, Mo, Y, Ni and W compounds. Among the compounds mentioned, Cu, Fe, Co and Zn oxides are particularly preferred. Mixed oxides such as indium-tin oxide (ITO) and antimony-tin oxide (ATO) or precursors of the compounds mentioned can also be used. However, among all the compounds mentioned, particular preference is given to CuO.

Component B preferably comprises at least one, in particular, oxidic metal and/or semimetal compound. Metal compounds having a trivalent or tetravalent metal ion, in particular, from the group consisting of Al, Fe, V, Cr, Si, Ti and Zr oxides, are particularly useful. Among the compounds mentioned, further preference is given to Al₂O₃, ZrO₂ and TiO₂, among which Al₂O₃ is particularly preferred.

Component C preferably comprises at least one member of the group of chalcogen-containing compounds, carbides and nitrides. Component C is preferably oxidic in nature. Unless already present in the composition as a constituent of component A or B, component C is, in particular, at least one member of the group consisting of aluminum oxide, boehmite, zirconium oxide, yttrium-stabilized zirconium oxide, chromium oxide, cerium oxide, iron oxide, silicon dioxide, tin dioxide and particularly preferably titanium dioxide.

Particular preference is given to the compositions whose components react at sintering temperatures to form an aluminate and/or a chromium-iron spinel (Fe(Cr,Fe)₂O₄). Furthermore, titanates can also be preferred. However, particular preference is given to aluminates, in particular copper aluminate.

In a particularly preferred composition, component B is present in excess. In the reaction of the particles of the inorganic component A with the particles of the inorganic component B, the particles of the component A accordingly react essentially completely while particles of the component B can also be present in substantial proportions in the reaction product because of the excess.

Component A is preferably present in the composition in an amount of from about 1% by weight to about 40% by weight, in particular, from about 5% by weight to about 15% by weight, based on the total weight of the solid constituents of the composition.

Component B is preferably present in the composition in an amount of from about 50% by weight to about 90% by weight, in particular from about 70% by weight to about 90% by weight, based on the total weight of the solid constituents of the composition.

Component C is preferably present in the composition in an amount of from about 1% by weight to about 40% by weight, in particular from about 5% by weight to about 15% by weight, based on the total weight of the solid constituents of the composition.

Preferred compositions comprise at least one preferably polar suspension medium. This is preferably water. The amount of suspension medium present in a composition is not critical in principle and can be varied depending on the use of the composition. In a preferred aspect, the composition is in the form of a low-viscosity, in particular paintable, suspension. In a further preferred embodiment, the composition is paste-like.

Apart from the above-mentioned components, our compositions frequently comprise further, preferably relatively coarse (having sizes up to the millimeter range or even greater), inorganic particles and/or fibers, in particular, as fillers.

Finally, it can be preferred that our compositions are essentially free of alkali metal and/or alkaline earth metal compounds.

We additionally provides a sintered ceramic reaction product which can, in particular, be produced from our compositions. It comprises at least one inorganic compound which has been formed by a chemical reaction during sintering and also at least one further inorganic compound.

The at least one compound formed during sintering is, in particular, a compound of the spinel type, preferably an aluminate and/or a chromium-iron spinel. Titanates can also be preferred, but copper aluminate is particularly preferred. However, in further aspects, the compound formed during sintering can also be a silicate.

The at least one further inorganic compound preferably comprises at least one, in particular oxidic, metal or semimetal compound. Particular preference is given to metal compounds having a trivalent or tetravalent metal ion, in particular at least one member of the group consisting of Al, Fe, V, Cr, Si, Ti and Zr oxides. The at least one further inorganic compound particularly preferably comprises at least one member of the group consisting of Al₂O₃, ZrO₂ and TiO₂, among which Al₂O₃ is particularly preferred.

Furthermore, a reaction product comprises, in preferred embodiments, at least one finely divided compound. This preferably has an average particle size of <1 μm, in particular, in the range from about 50 nm to about 200 nm. The at least one nanosize compound is, in particular, at least one chalcogen-containing compound, a carbide and/or a nitride. If not already present as the at least one further inorganic compound in the reaction product, the at least one nanosize compound comprises at least one member of the group consisting of aluminum oxide, boehmite, zirconium oxide, yttrium-stabilized zirconium oxide, chromium oxide, cerium oxide, iron oxide, SiO₂, tin dioxide and particularly preferably titanium dioxide.

A reaction product preferably has a heterogeneous structure composed of various particles which are firmly joined to one another. The further inorganic compound is preferably present in the form of elongated, relatively large particles, preferably having an average length of <100 μm, in particular <50 μm, in the reaction product. The at least one compound formed during sintering is, in particular, present in the form of particles which have average particle sizes of <10 μm, in particular <5 μm, and join the elongated particles to one another in the reaction product. In addition, particles of the at least one nanosize compound may also be located in the voids between the larger particles.

The presence of the elongated particles may be attributable to crystal particles of a composition having grown preferentially in one direction during sintering. This is presumably attributable to the formation of a local eutectic at the grain boundaries of the crystals to form a melt phase which is responsible for the crystals growing in a preferential direction. It is assumed that the presence of a nanosize compound may lead to a further reduction in the temperature of the sintered ceramic being formed which is required for formation of the melt phase.

Reaction products which are preferred preferably have a composition in which the above-mentioned constituents are present in the following proportions:
from about 50% by weight to about 90% by weight, in particular, from about 70% by weight to about 90% by weight, of the at least one further inorganic compound,
from about 5% by weight to about 25% by weight, in particular, from about 5% by weight to about 15% by weight, of the at least one compound formed during sintering.

In a particularly preferred aspect, the reaction product comprises from 70% by weight to 90% by weight of aluminum oxide, from 5% by weight to 15% by weight of copper aluminate and from 5% by weight to 15% by weight of titanium dioxide.

In a further particularly preferred aspect, the reaction product comprises from 70% by weight to 90% by weight of aluminum oxide, from 5% by weight to 15% by weight of iron aluminate and from 5% by weight to 15% by weight of titanium dioxide.

Reaction products are preferably essentially free of alkali metal and/or alkaline earth metal ions.

A reaction product can either be present in the form of a high-temperature-stable shaped body or in the form of a high-temperature-stable layer or coating. It has, in particular, an extremely high strength and hardness. Thus, in preferred aspects, it has a flexural strength in the range from about 200 MPa to about 300 MPa, in particular, about 250 MPa (determined in accordance with DIN ISO 60672). Vickers hardnesses were determined on reaction products which are preferred and these were, in particular, in the range about 12 to about 18 GPa.

The uses of a composition for producing inorganic shaped bodies, layers and/or coatings and a reaction product are also disclosed.

Our compositions can be further processed particularly well by slip casting, tape casting, extrusion, pressure slip casting and also cold and hot isostatic pressing to give shaped bodies, layers and/or coatings.

Among the preferred uses, the coating of articles such as heat exchange tubes in power stations may be particularly emphasized. During the sintering process, a protective layer which is able to withstand chemical attack, in particular, at high temperatures, is formed on the heat exchange tube from an applied composition. Thus, for example, highly aggressive slags as are formed in combustion processes in power stations and incineration plants do not attack a ceramic layer or coating, even at 900° C. A further interesting application of ceramic reaction products is in the field of ceramic filters where the reaction product is suitable both as ceramic support material and also for coating a ceramic support. Furthermore, it has been found that the production of monolithic, shaped ceramic bodies from a composition offers significant advantages over the prior art, since it is possible to achieve a high component strength even at low temperatures. In other words, shaped ceramic bodies having high strengths can be obtained at comparatively low sintering temperatures.

Finally, we provide a process for producing a high-temperature-stable ceramic coating on an article and any article which is provided with a reaction product, in particular, with a coating.

The process comprises application of a composition to an article, if appropriate removal of solvent present in the composition and sintering of the applied composition.

Sintering of the composition is preferably carried out at a temperature of >900° C., in particular, >1000° C. The composition is preferably sintered for a period of at least about 2 hours, in particular from about 2 to about 24 hours. After cooling, a high-temperature-stable, ceramic coating is obtained.

### Example 1

In a glass beaker equipped with a high-speed stirrer, an aqueous solution which has been set to a pH of 2 by means of HNO₃ is admixed with submicron (mean particle size in the range from 100 nm to 1 μm) α-Al₂O₃ (89.5% by weight) and the mixture is homogenized for one hour. Nanosize TiO₂ (rutile; 6.5% by weight) is subsequently added while stirring vigorously and micron CuO (4% by weight) is stirred in. The solids content of the suspension after homogenization was 80% by weight.

The casting slip obtained in this way can be processed readily and is poured into a plaster mold and dried overnight at room temperature. The green body is fired at 1100° C. for two hours. Sintering leads to brown shaped parts having a largely dense microstructure and very good mechanical strength and hardness.

Analysis indicated a ceramic microstructure comprising Al₂O₃, CuAl₂O₄ and TiO₂.

The specimen, which has excellent strength and high-temperature properties, comprises, according to quantitative X-ray diffraction analysis, about 87% of aluminum oxide, more precisely α-alumina (α-Al₂O₃), about 7% of copper aluminate (CuAl₂O₄) and about 6% of titanium dioxide, more precisely rutile (TiO₂).

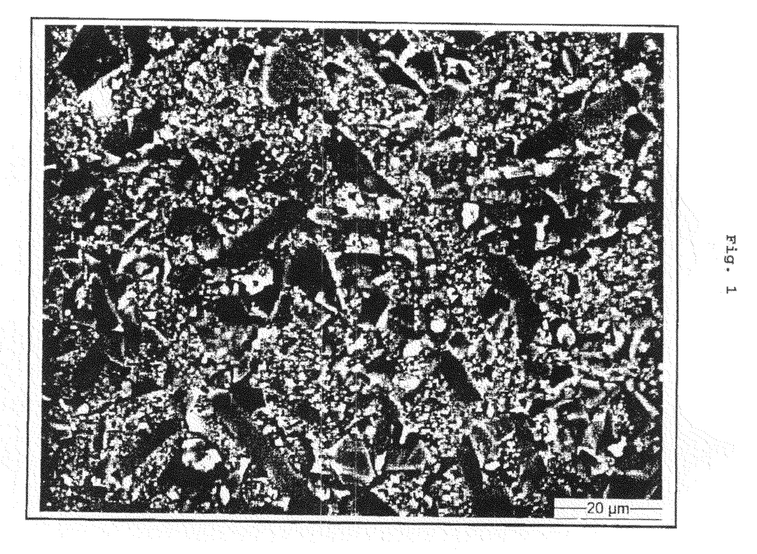

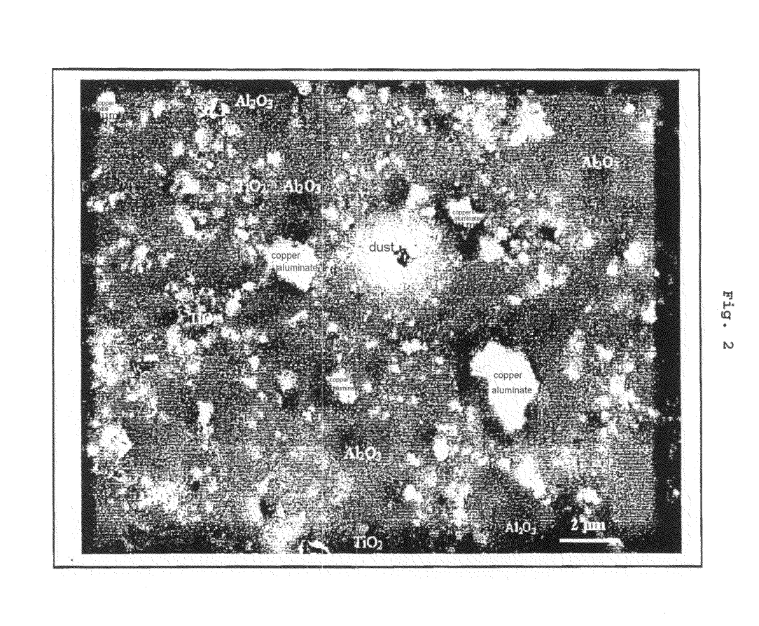

FIGS. 1 and 2 show scanning electron micrographs of the ceramic microstructure produced. Elongated, rod-shaped crystals, which are aluminum oxide crystals, can readily be discerned. It is presumed that not only the above-mentioned high-temperature-stable phase but also the rod-shaped alumina crystals make a contribution to the extremely high strength of the ceramic reaction product according to the invention.

The formation of the rod-shaped alumina crystals can be attributed to the aluminum oxide grains in the starting composition having grown preferentially in one direction during sintering. The copper oxide added in a substoichiometric amount in the starting composition accumulates at the grain boundaries of the aluminum oxide grains. At temperatures above 900° C., in particular above 1000° C., a local eutectic, i.e. a melt phase, which is responsible for the aluminum oxide grains growing in a preferential direction is formed at the grain boundaries.

The eutectic which allows formation of a melt phase is formed at about 90% of aluminum oxide and 10% of copper oxide. The presence of the nanocrystalline titanium dioxide reinforces this effect further.

In the figures, TiO₂ particles and copper aluminate particles can be seen in addition to aluminum oxide (see, in particular, annotations on the high-resolution scanning electron micrograph of a polished section (HSEM) in FIG. 2). FIG. 2 shows that titanium dioxide (small light-colored regions) and copper aluminate, either as CuAl₂O₄ or as CuAlO₂, (large light-colored regions) are present in addition to the alumina oxide crystals (dark in the image).

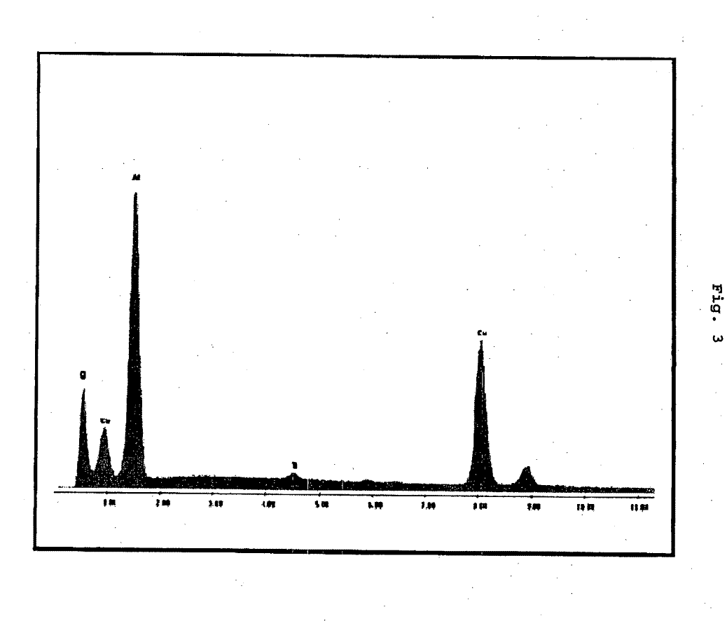

The copper aluminate was able to be protected by element mapping and EDX spectra (FIG. 3) of the large light-colored regions in the HR scanning electron micrograph. Virtually exclusively oxygen, copper and aluminum and essentially no titanium were found here. Element mapping by means of an EDX scan of the dark regions indicated exclusively oxygen and aluminum, while titanium and oxygen could be assigned to the small light-colored grains.

### Example 2

112 g of an aqueous mixture (solids content: 75% by weight, water: 25% by weight) of a submicron aluminum oxide (70% by weight) together with nanosize titanium dioxide (5% by weight) are homogenized for one hour in a high-speed stirrer provided with dissolver disk and ZrO₂ milling media. 3.2 g of Cr₂O₃ and 1.4 g of γ-Fe₂O₃ are added to this mixture and the mixture is stirred at high speed for a further one hour. This gives a relatively fluid casting slip which is likewise poured onto plaster and dried overnight. After sintering at 1100° C. for 4 hours, a gray shaped body whose analysis indicates a mixture of aluminum oxide, chromium-iron spinel and titanium dioxide (rutile) is formed.

### Example 3

87.1 g of a mixture (solids content: 75% by weight, water: 25% by weight) of a submicron aluminum oxide (70% by weight) and nanosize titanium dioxide (5% by weight) are homogenized for one hour in a high-speed stirrer provided with dissolver disk and ZrO₂ milling media. 2.5 g of ZnO are added to this mixture and the mixture is stirred at high speed for a further one hour. This gives a viscous white casting slip which is likewise poured onto plaster and dried overnight. After sintering at 1100° C. for 4 hours, a white shaped body whose analysis indicates a mixture of aluminum oxide, zinc aluminate and titanium dioxide (rutile) has been formed.

### Example 4

271 g of coarse aluminum oxide (particle size: 5 μm) are slurried in 55 g of deionized water and the mixture is homogenized for one hour by means of a high-speed stirrer. 11.1 g of micron CuO and 19.7 g of nanosize TiO₂ are added gradually to the suspension and the mixture is homogenized for a further one hour. Cu(NO₃)₂ can also be used here in place of the CuO. This gives a viscous reddish casting slip which is likewise poured onto plaster and dried overnight. After sintering at 1100° C. for 12 hours, a brown shaped body whose analysis indicates a mixture of aluminum oxide, copper aluminate and titanium dioxide (rutile) has been formed. If Cu(NO₃)₂ is used, a two hour halt time at 500° C. has to be employed.

### Example 5

200 ml of water are placed in a vessel and admixed with 32.0 g of Duramax D 3005 (from Rohm & Haas). 800 g of Al₂O₃ followed by 32.8 g of CuO and then 58.2 g of TiO₂ are then slowly added while stirring. The mixture is subsequently homogenized in a ball mill.

The casting slip obtained in this way can be processed readily and is poured into a plaster mold and dried overnight at room temperature. The green body is fired at 1100° C. for two hours. Sintering leads to brown shaped parts having a largely dense microstructure and very good mechanical strength and hardness.

Analysis indicated a ceramic microstructure comprising Al₂O₃, CuAl₂O₄ and TiO₂.

### Example 6

The casting slip obtained in example 1 was applied in a layer to a metallic heat exchange tube and after drying overnight was sintered at a temperature of 1100° C. for a period of 2 hours. The composition formed a protective layer on the heat exchange tube.

The protective layer was tested by bringing it into contact with slags from German coal-fired power stations and heated at 900° C. for a period of 2 hours. However, no reaction between slag and protective layer (no adhering material or the like) was observed.

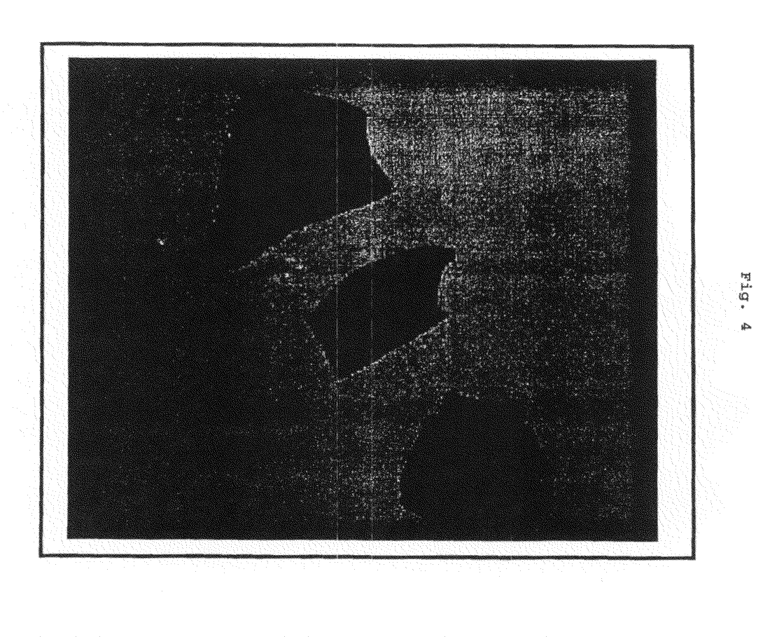

FIG. 4 shows such a protective layer which has been contacted with power station slag.

### Example 7

A preferred composition for producing a shaped ceramic body has the following composition:

(1) 60.35% by weight of Al₂O₃ (submicron particle size)
(2) 2.49% by weight of CuO (micron particle size)
(3) 6.03% by weight of cellulose Walocell 40000
(4) 10.86% by weight of water (deionized)
(5) 11.67% by weight of TiO₂ suspension (average particle size: 20-30 nm, solids content: 37.7% by weight)
(6) 8.61% of plasticizer PEG 400

The components 1-3 (dry components) were premixed in an Eirich mixer for 10 minutes at medium speed. The components 4-6 (liquid components) were likewise premixed and then added to the powder mixture. The composition was mixed for 5 minutes at high speed. This gave a fine granular extrudable material.

The granular material was introduced into a screw extruder (from ECT) and extruded by means of appropriate dies to produce pipes, strips, U-profiles or L-profiles. The extruded parts were cut to the required length (from 10 cm to 100 cm) and dried overnight in air. Sintering of the dried green bodies was carried out at 1200° C. with a hold time of two hours.

1-28. (canceled)

29. A composition for producing high-temperature-stable ceramic layers, coatings and shaped bodies, which comprises particles of an inorganic component A and particles of an inorganic component B which together form a eutectic mixture and react at least partly with one another at a sintering temperature, resulting in formation of at least one ternary spinel compound.

30. The composition as claimed in claim 29, comprising nanosize particles of an inorganic component C.

31. The composition as claimed in claim 30, wherein the nanosize particles have an average particle size of <100 nm.

32. The composition as claimed in claim 29, wherein the particles of component A are at least partly nanosize.

33. The composition as claimed in claim 32, wherein the particles of component A have an average particle size of <100 nm.

34. The composition as claimed in claim 29, wherein the particles of component B are at least partly nanosize.

35. The composition as claimed in claim 34, wherein the particles of component B have an average particle size of <100 nm.

36. The composition as claimed in claim 29, wherein component A comprises at least one metal compound.

37. The composition as claimed in claim 29, wherein component A comprises at least one metal compound having a divalent metal ion.

38. The composition as claimed in claim 29, wherein component A comprises at least one metal compound selected from the group consisting of oxidic compounds of Cu, Fe, Co, Zn, Mn, Ce, Sn, Cd, In, Ta, Nb, V, Mo, Y, Ni and W.

39. The composition as claimed in claim 29, wherein component B comprises at least one metal compound.

40. The composition as claimed in claim 39, wherein the at least one metal compound comprises a trivalent or tetravalent metal ion.

41. The composition as claimed in claim 39, wherein the at least one metal compound is at least one member selected from the group consisting of Al, Fe, V, Cr, Ti and Zr oxides.

42. The composition as claimed in claim 29, wherein component B comprises at least one semimetal compound.

43. The composition as claimed in claim 30, wherein component C comprises at least one member selected from the group consisting of chalcogen-containing compounds, carbides and nitrides.

44. The composition as claimed in claim 30, wherein component C is oxidic.

45. The composition as claimed in claim 29, wherein its components react at the sintering temperature to form an aluminate.

46. The composition as claimed in claim 29, wherein its components react at the sintering temperature to form a chromium-iron spinel (Fe(Cr,Fe)₂O₄).

47. The composition as claimed in claim 29, wherein component B is present in excess.

48. The composition as claimed in claim 29, further comprising a suspension medium.

49. The composition as claimed in claim 29, wherein the suspension medium is polar.

50. A sintered ceramic reaction product produced from a composition as claimed in claim 29, comprising at least one inorganic compound which has been formed by a chemical reaction during sintering and also at least one further inorganic compound.

51. The reaction product as claimed in claim 50, wherein the at least one compound formed during sintering is a spinel compound.

52. The reaction product as claimed in claim 50, wherein the at least one compound formed during sintering comprises an aluminate.

53. The reaction product as claimed in claim 50, wherein the at least one compound formed during sintering comprises a chromium-iron spinel.

54. The reaction product as claimed in claim 50, wherein the at least one further inorganic compound comprises a metal compound.

55. The reaction product as claimed in claim 50, wherein the at least one further inorganic compound comprises a metal compound having a trivalent or tetravalent metal ion.

56. The reaction product as claimed in claim 54, wherein the metal compound is at least one member selected from the group consisting of Al, Fe, V, Cr, Ti and Zr oxides.

57. The reaction product as claimed in claim 50, wherein the at least one further inorganic compound comprises a semimetal compound.

58. The reaction product as claimed in claim 50, having a heterogeneous structure composed of various particles which are joined to one another.

59. The reaction product as claimed in claim 50, wherein the at least one compound formed during sintering is present in the form of particles having average particle sizes of <10 μm in the reaction product.

60. The reaction product as claimed in claim 50, wherein the further inorganic compound is present in the form of elongated particles in the reaction product.

61. The reaction product as claimed in claim 60, wherein the elongated particles have an average length of <100 μm.

62. The reaction product as claimed in claim 50, comprising at least one nanosize compound having an average particle size of <100 nm.

63. The reaction product as claimed in claim 62, wherein the at least one nanosize compound has an average particle size in the range from about 1 nm to about 100 nm.

64. The reaction product as claimed in claim 62, wherein the at least one nanosize compound comprises at least one chalcogen-containing compound.

65. The reaction product as claimed in claim 62, wherein the at least one nanosize compound comprises at least one carbide.

66. The reaction product as claimed in claim 62, wherein the at least one nanosize compound comprises at least one nitride.

67. The reaction product as claimed in claim 50, comprising
from about 50% by weight to about 90% by weight of the at least one further inorganic compound,
from about 5% by weight to about 25% by weight of the at least one compound formed during sintering.

68. The reaction product as claimed in claim 50, comprising from about 70% by weight to about 90% by weight of aluminum oxide, from about 5% by weight to about 15% by weight of copper aluminate and from about 5% by weight to about 15% by weight of titanium dioxide.

69. The reaction product as claimed in claim 50, comprising from about 70% by weight to about 90% by weight of aluminum oxide, from about 5% by weight to about 15% by weight of iron aluminate and from about 5% by weight to about 15% by weight of titanium dioxide.

70. The reaction product as claimed in claim 50, in the form of a high-temperature-stable shaped body.

71. The reaction product as claimed in claim 50, in the form of a high-temperature-stable layer or coating.

72. A method for producing inorganic shaped bodies, layers and/or coatings, comprising forming a composition as claimed in claim 29 into the shaped bodies, layers and/or coatings.

73. A method for coating heat exchange tubes in power stations comprising applying a composition as claimed in claim 29 to the heat exchange tubes.

74. A ceramic filter comprising a reaction product as claimed in claim 50.

75. An article comprising a reaction product as claimed in claim 50.

76. A process for producing a high-temperature-stable ceramic coating on an article, comprising applying a composition as claimed in claim 29 to the article, removing solvent present in the composition and sintering the composition.
